(19) United States
(12) Patent Application Publication
(10) Pub. No.: US 2025/0080642 A1
(43) Pub. Date: Mar. 6, 2025

(54) MANAGING INCOMING CALLS IN AN ELECTRONIC DEVICE

(71) Applicant: MOTOROLA MOBILITY LLC, WILMINGTON, DE (US)

(72) Inventors: AMIT KUMAR AGRAWAL, BANGALORE (IN); MANAS RANJAN, DELHI (IN); THIRUMARAI SELVI SEERANGAN, BANGALORE (IN)

(21) Appl. No.: 18/456,638

(22) Filed: Aug. 28, 2023

(51) Int. Cl. H04M 1/72463; G06F 21/32; H04M 1/60

(52) U.S. Cl. CPC H04M 1/72463; G06F 21/32; H04M 1/605

(57) ABSTRACT

An electronic device, a method and a computer program product for managing incoming calls. The method includes detecting, via a processor, activation of an electronic device to a second operating mode from a first operating mode. In response to detecting an incoming call while the electronic device is in the second operating mode, the method further includes determining whether the second operating mode enables a secondary user to respond to the incoming call, and in response to the secondary user being able to respond to the incoming call, detecting whether the incoming call is responded to by the secondary user. In response to detecting that the incoming call was responded to by the secondary user, the method further includes recording a response to a secondary user responded call report and presenting the secondary user responded call report following detection of a primary user monitoring the electronic device.

### BACKGROUND

### 1. Technical Field

The present disclosure generally relates to electronic devices and in particular to managing incoming calls in an electronic device.

### 2. Description of the Related Art

Electronic devices, such as cell phones, tablets, and laptops, are widely used for video, voice, and text communication and data transmission. These electronic devices are commonly owned by a primary user, such as a parent, and shared with other (secondary) users such as family members including children. For example, a parent may allow a child to play a game on the parent's electronic device. The electronic device can receive incoming phone calls and alert the user to the incoming call using a variety of on-screen messages, sounds, such as ring tones, and/or by vibrations. When the electronic device is being used by a child, and an incoming phone call is received, the child may accept the incoming call or may decline the incoming call. Unfortunately, when a child is operating the electronic device, the child may decline an important incoming call that a parent desires to be answered or the child may accept a call that a parent desires to not be answered. The child's response to the incoming call oftentimes occurs without the parent's knowledge.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2A is an example illustration of the front of an electronic device with multiple front cameras, according to one or more embodiments;

FIG. 2B is an example illustration of the rear of an electronic device with multiple rear cameras, according to one or more embodiments;

FIG. 3 is a block diagram of example contents of the system memory of the example electronic device of FIG. 1, according to one or more embodiments;

FIG. 4A is an example illustration of a graphical user interface (GUI) presented on a display of an electronic device that enables a primary user to configure electronic device options for use during a secondary operating mode, according to one or more embodiments;

FIG. 4B is an example illustration of a GUI presented on a display of an electronic device during the detection of an incoming call, according to one or more embodiments;

FIG. 5 is an example illustration of a secondary (child) user interacting with displayed content on an electronic device display on which an incoming call notification is presented, according to one or more embodiments;

FIG. 6 is an example illustration of a primary user monitoring the electronic device of FIG. 1 after an incoming call has been responded to by a secondary user, according to one or more embodiments;

FIG. 7A is an example illustration of a GUI presented on a display of an electronic device showing an example secondary user responded (SUR) call report, according to one or more embodiments;

FIG. 7B is an example illustration of a GUI presented on a display of an electronic device showing another example SUR call report, according to one or more embodiments;

FIG. 8 depicts a flowchart of a method by which an electronic device manages an incoming call, based on whether a primary user or a secondary user is accessing the device, according to one or more embodiments;

FIG. 9 depicts a flowchart of a method by which an electronic device presents a SUR call report to a primary user, according to one or more embodiments;

FIG. 10 depicts a flowchart of a method by which an electronic device manages additional incoming calls, according to one or more embodiments; and

FIG. 11 depicts a flowchart of a method by which an electronic device gradually increases a ringer volume during an incoming call, according to one or more embodiments.

### DETAILED DESCRIPTION

According to one aspect of the disclosure, the illustrative embodiments provide an electronic device, a method, and a computer program product for managing incoming calls to an electronic device. In a first embodiment, an electronic device includes a first camera and a memory having stored thereon a call management module (CMM) for managing incoming calls to the electronic device. The electronic device includes at least one processor communicatively coupled to the first camera and to the memory. The at least one processor executes program code of the CMM, which enables the electronic device to detect activation of the electronic device to a second operating mode from a first operating mode. The first operating mode is associated with the electronic device being operated by a primary user of the electronic device, and the second operating mode is associated with the electronic device being operated by a secondary user of the electronic device. In response to detecting a first incoming call while the electronic device is in the second operating mode, the at least one processor determines whether the second operating mode enables the secondary user to respond to the first incoming call, and in response to the secondary user being able to respond to the first incoming call, detects whether the first incoming call is responded to by the secondary user. In response to detecting that the first incoming call was responded to by the secondary user, the at least one processor further records response information during the first incoming call to a secondary user responded (SUR) call report. The recorded response includes call identification details of the incoming call and can include a recording of any conversation that occurs between the secondary user and the incoming caller. The at least one processor autonomously presents, to the primary user, the secondary user responded call report with call response details, following detection of the primary user subsequently monitoring the electronic device.

According to another embodiment, the method includes detecting, via at least one processor, activation of an electronic device to a second operating mode from a first operating mode. The first operating mode is associated with the electronic device being operated by a primary user of the electronic device, and the second operating mode is associated with the electronic device being operated by a secondary user of the electronic device. In response to detecting a first incoming call while the electronic device is in the second operating mode, the method includes determining whether the second operating mode enables the secondary user to respond to the first incoming call, and in response to the secondary user being able to respond to the first incoming call, detecting whether the first incoming call is responded to by the secondary user. In response to detecting that the first incoming call was responded to by the secondary user, the method includes recording response information during the first incoming call to a secondary user responded (SUR) call report. The recorded response includes call identification details of the incoming call and can include a recording of any conversation that occurs between the secondary user and the incoming caller. The method includes autonomously presenting the secondary user responded call report with call response details following detection of the primary user subsequently monitoring the electronic device.

According to an additional embodiment, a computer program product includes a computer readable storage device having stored thereon program code that, when executed by at least one processor of an electronic device having a first camera, the program code enables the electronic device to complete the functionality of one or more of the above-described methods.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural. programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

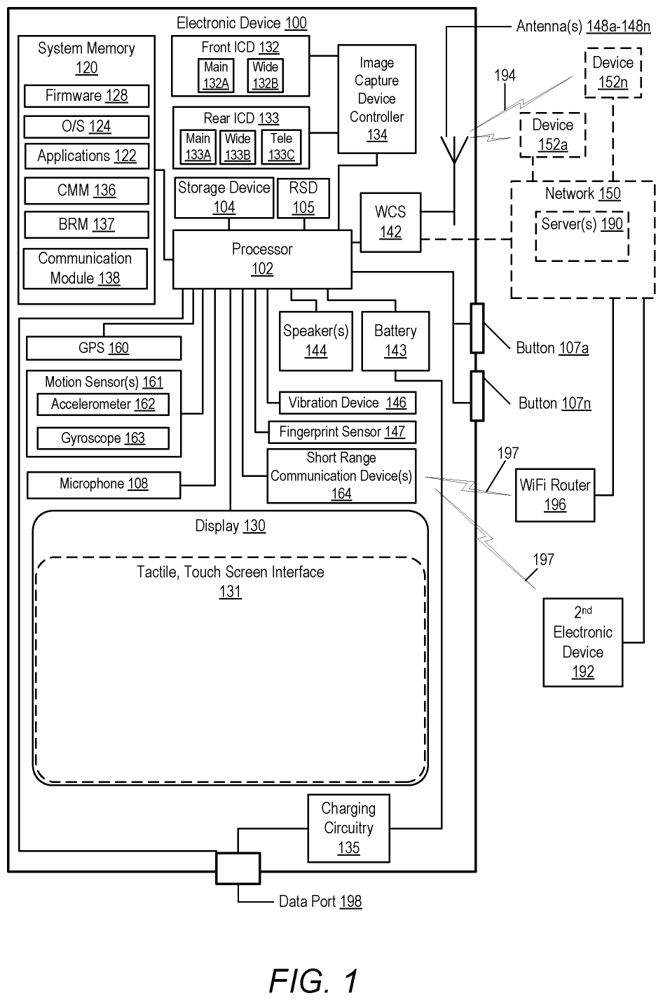

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include capability to receive an incoming communication and one or more sensors, e.g., a camera, for identifying different users of the device. Electronic device 100 includes processor 102, which is communicatively coupled to storage device 104, system memory 120, input devices, (introduced below), output devices, such as display 130, and image capture device (ICD) controller 134. Processor 102 can include processor resources such as a central processing unit (CPU) that support computing, classifying, processing and transmitting of data and information. Processor 102 can further include graphic processing units (GPU) and digital signal processors (DSP) that also support computing, classifying, processing and transmitting and receiving of data and information.

According to one or more embodiments, ICD controller 134 performs or supports functions such as, but not limited to, operating multiple cameras, adjusting camera settings and characteristics (shutter speed, f/stop, ISO exposure, zoom control, etc.) of the multiple cameras, etc. ICD controller 134 can perform these functions in response to commands received from processor 102. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102.

System memory 120 may be a combination of volatile and non-volatile memory, such as random access memory (RAM) and read-only memory (ROM). System memory 120 can store program code or similar instructions and data associated with firmware 128, an operating system 124, applications 122, call management module (CMM) 136, biometric recognition module (BRM) 137, and communication module 138. CMM 136 includes program code that is executable by processor 102 to enable electronic device 100 to manage incoming calls to the electronic device. BRM 137 includes program code that is executed by processor 102 to enable electronic device 100 to perform authentication or recognition of at least a primary user of electronic device 100. Communication module 138 includes program code that is executed by processor 102 to enable electronic device 100 to communicate with other external devices and systems.

Although depicted as being separate from applications 122, CMM 136, BRM 137, and communication module 138 may each be implemented as an application. Processor 102 loads and executes program code stored in system memory 120, including program code associated with applications 122 and program code associated with CMM 136, BRM 137, and communication module 138.

In one or more embodiments, electronic device includes removable storage device (RSD) 105, which is inserted into an RSD interface (not shown) that is communicatively coupled via system interlink to processor 102. In one or more embodiments, RSD 105 is a non-transitory computer program product or computer readable storage device. RSD 105 may have a version of CMM 136 and BRM 137 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device is utilized interchangeably to be synonymous with and/or refer to any one of front or rear cameras 132, 133. Front cameras (or image capture device (ICD)) 132 are communicatively coupled to ICD controller 134, which is communicatively coupled to processor 102. ICD controller 134 supports the processing of signals from front cameras 132. Front cameras 132 can each capture images that are within the respective field of view (FOV) of image capture device 132. As illustrated, electronic device 100 includes several front cameras 132. First front camera 132A is a main camera that captures a standard angle FOV. Second front camera 132B is wide angle camera. Front cameras 132A and 132B can be collectively referred to as front cameras 132A-132B. While two front cameras 132A-132B are shown, electronic device 100 can have more than two front cameras. In one embodiment, front cameras 132A-132B can be used to provide biometric data to identify or authenticate a primary and/or secondary user of electronic device 100.

Electronic device 100 further includes several rear cameras 133. Main rear camera 133A is a main camera that captures a standard or regular angle FOV. Wide angle rear camera 133B is a wide-angle camera that captures a wide angle FOV. Telephoto rear camera 133C is a telephoto camera that captures a telephoto FOV (zoom or magnified). While three rear cameras are shown, electronic device 100 can have less than three rear cameras, such as having two rear cameras or can have more than three rear cameras.

Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B and 133C. Front cameras 132A and 132B can be collectively referred to as front cameras 132, and rear cameras 133A, 133B and 133C can be collectively referred to as rear cameras 133, for simplicity.

Electronic device 100 can further include data port 198, charging circuitry 135, and battery 143 for providing electrical power to the various electronic components of electronic device 100. Electronic device 100 further includes microphone 108, one or more output devices such as speakers 144, and one or more input buttons 107a-n. Input buttons 107a-n may provide controls for volume, power, and/or image capture devices 132, 133. Microphone 108 can also be referred to as audio input device 108. Microphone 108 can be used to provide biometric data to identify or authenticate a user. Microphone 108 and input buttons 107a-n can also be referred to generally as input devices. Speakers 144 can provide an audio alert to a user, such as a ring tone, during an incoming call to electronic device 100.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150. In one embodiment, communication network devices 152a-152n contain electronic communication equipment to allow communication with electronic device 100.

Wireless network 150 further allows electronic device 100 to wirelessly communicate with second electronic devices 192, which can be similarly connected to wireless network 150 via one of network communication devices 152a-152n. Wireless network 150 is communicatively coupled to wireless fidelity (WiFi) router 196. Electronic device 100 can also communicate wirelessly with wireless network 150 via communication signals 197 transmitted by short range communication device(s) 164 to and from WiFi router 196, which is communicatively connected to network 150. In one or more embodiment, wireless network 150 can include one or more servers 190 that support wireless exchange of voice, data, and video and other communication between electronic device 100 and second electronic device 192.

Electronic device 100 further includes short range communication device(s) 164. Short range communication device 164 is a low powered transceiver that can wirelessly communicate with other devices. Short range communication device(s) 164 can include one or more of a variety of devices supporting different corresponding wireless protocols, such as a near field communication (NFC) device, a Bluetooth device, and/or a wireless fidelity (Wi-Fi) device. Short range communication device(s) 164 can wirelessly communicate with WiFi router 196 via communication signals 197. In one embodiment, electronic device 100 can receive Internet or Wi-Fi based calls via short range communication device(s) 164. In one embodiment, electronic device 100 can communicate with WiFi router 196 wirelessly via short range communication device(s) 164. In an embodiment, WCS 142, antennas 148a-148n and short-range communication device(s) 164 collectively provide communication interface(s) of electronic device 100. Short range communication device(s) 164 can wirelessly communicate with electronic device 192 via communication signals 197. These communication interfaces enable electronic device 100 to communicatively connect to at least one second electronic device 192 via at least one network.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an incoming call or message in order to provide an alert or notification to a user of electronic device 100. According to one aspect of the disclosure, display 130, speakers 144, and vibration device 146 can generally and collectively be referred to as output devices.

Fingerprint sensor 147 can be used to provide biometric data or images to identify or authenticate a user. GPS device 160 can provide time data and location data about the physical location of electronic device 100 using geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100.

In the description of each of the following figures, reference is also made to specific components illustrated within the preceding figure(s). Similar or same components are presented with the same reference number.

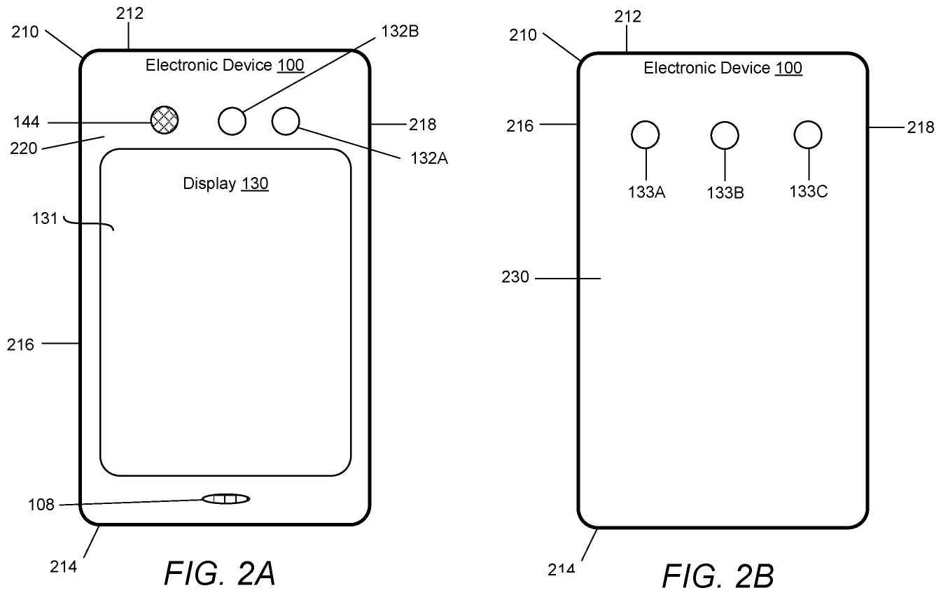

Turning to FIG. 2A, additional details of the front surface of electronic device 100 are shown. Electronic device 100 includes a housing 210 that contains the components of electronic device 100. Housing 210 includes a top 212, bottom 214, and opposed sides 216 and 218. Housing 210 further includes a front surface 220. Microphone 108, display 130, front cameras 132A, 132B and speaker 144 are located on/at front surface 220.

With additional reference to FIG. 2B, additional details of the rear surface of electronic device 100 are shown. Housing 210 further includes a rear surface 230. Various components of electronic device 100 are located on/at rear surface 230, including rear cameras 133. Rear main camera 133A, rear wide-angle camera 133B, and rear telephoto camera 133C are illustrated located on rear surface 230. Each of the multiple rear facing cameras can have different image capturing characteristics. For example, rear telephoto camera 133C can include an optical zoom lens that is optimized for capturing images of distant objects.

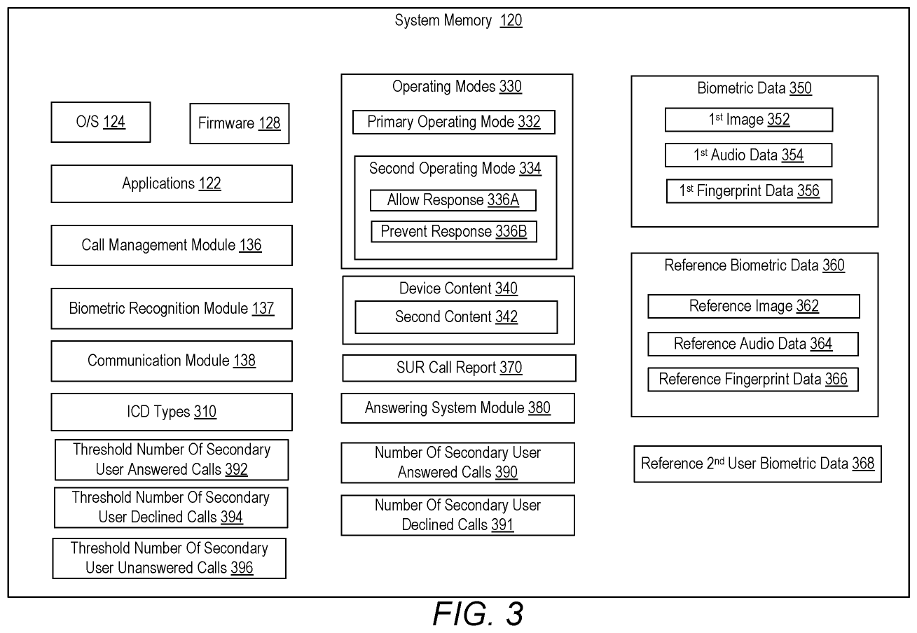

Referring to FIG. 3, there is shown one embodiment of example contents of system memory 120 of electronic device 100. System memory 120 includes data, software, and/or firmware modules, including applications 122, operating system 124, firmware 128, CMM 136, BRM 137, and communication module 138.

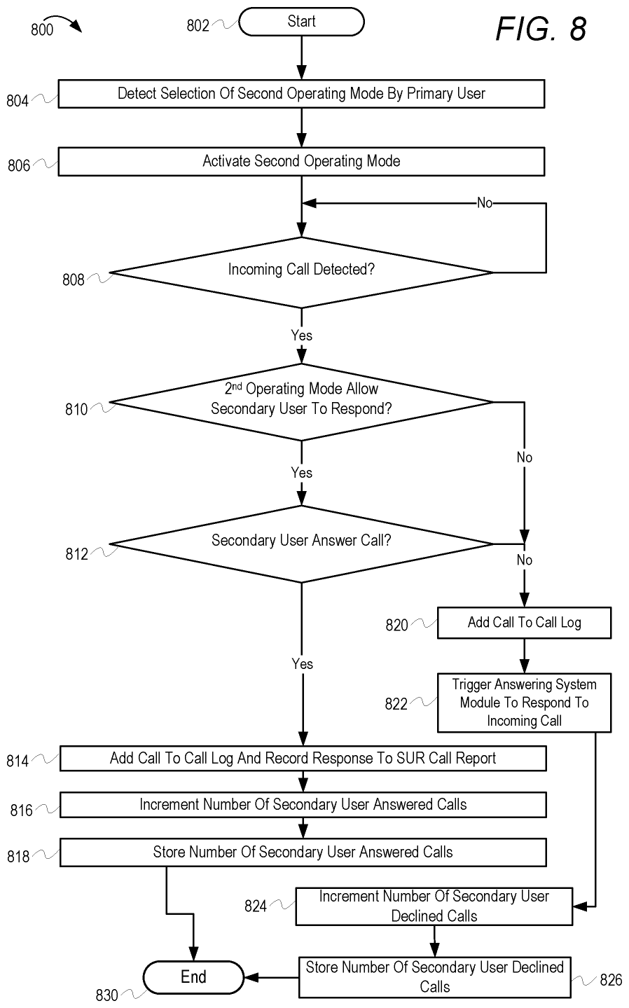

CMM 136 and BRM 137 include program code that is executed by processor 102 to enable electronic device 100 to perform the various features of the present disclosure. In one or more embodiments, CMM 136 and BRM 137 enables electronic device 100 to manage and record incoming calls to electronic device 100, in part based on whether the electronic device is being accessed/used by a primary user or a secondary user. In one or more embodiments, execution of CMM 136 and BRM 137 by processor 102 enables/configures electronic device 100 to perform the processes presented in the flowcharts of FIGS. 8-11, as will be described below.

Communication module 138 enables electronic device 100 to communicate with wireless network 150 and with other devices, such as second electronic device 192, via one or more of audio, text, and video communications.

System memory 120 further includes camera or ICD types 310. ICD types 310 contain information identifying the specific front and rear cameras 132A, 132B, 133A, 133B and 133C that are included in electronic device 100 and settings/parameters of each camera.

System memory 120 further includes operating modes 330. Operating modes 330 are modes of operation associated with different users of electronic device 100. Operating modes 330 include primary operating mode 332 and second operating mode 334. Primary operating mode 332 corresponds to the electronic device being operated by a primary user of the electronic device. For example, the primary user can be an owner of the electronic device or an individual that has authenticated to electronic device 100 as an authorized user of the electronic device. Second operating mode 334 corresponds to the electronic device being operated by a secondary user of the electronic device. In an embodiment, the secondary user can be a child. In one embodiment, the primary user of the electronic device can select the second operating mode 334 for electronic device 100 to operate in. In another embodiment, electronic device 100 can automatically select an operating mode for electronic device 100 based on an identification of whether the current user of electronic device 100 is the primary user or the secondary user. According to one aspect of the disclosure, second operating mode 334 is a child safe mode that restricts access to only a subset of second content 342 that can be accessed by the electronic device in the primary operating mode 332. Second operating mode 334 includes two sub-modes, allow response mode 336A and prevent response mode 336B. Allow response mode 336A enables a secondary user of electronic device 100 to respond to an incoming call. Prevent response mode 336B prevents a secondary user of electronic device 100 from responding to an incoming call.

System memory 120 further includes device content 340 and second content 342. Device content 340 includes various data and information stored on or allowed access by electronic device 100. In an example embodiment, device content 340 can include photos, video, text messages, applications, websites, data and phone access information. Second content 342 can be a restricted subset of device content 340.

In one embodiment, the primary operating mode 332 allows access to all of the device content 340 that can be accessed by electronic device 100 and the second operating mode 334 is a child safe mode that restricts access to only second content 340 that can be accessed by electronic device 100.

System memory 120 further includes biometric data 350 and reference biometric data 360. Biometric data 350 is received from at least one sensor of electronic device 100. Microphone 108, front cameras 132A-132B, and fingerprint sensor 147 can be referred to as sensors of electronic device 100 and can provide biometric data 350. Biometric data 350 comprises first image 352, first audio data 354 and first fingerprint data 356. First image 352 can include a facial image of a current user of electronic device 100 that is captured by at least one of front cameras 132A or 132B. First audio data 354 can include audio data corresponding to a current user of electronic device 100 that is captured by microphone 108. First fingerprint data 356 can include fingerprint data corresponding to a current user of electronic device 100 that is sensed by fingerprint sensor microphone 108.

Reference biometric data 360 is stored authenticated biometric data of a primary user associated with electronic device 100. Reference biometric data 360 comprises reference image 362, reference audio data 364, and reference fingerprint data 366. Reference image 362 is a stored authenticated facial image of a primary user of electronic device 100. A primary user is an individual associated with the electronic device that has previously registered or enrolled with the electronic device and has thus been authenticated to access all content of electronic device 100. Reference audio data 364 is stored authenticated audio of the speech of a primary user of electronic device 100. Reference fingerprint data 366 is stored authenticated fingerprint image of the fingerprint of a primary user of electronic device 100. In one or more embodiments, system memory 120 can also include reference second user biometric data 368 which can be used to identify and/or authenticate second user and trigger automatic transition of the electronic device 100 to operate in the second operating mode.

System memory 120 further includes secondary user responded (SUR) call report 370. SUR call report 370 is a report that contains call response details when a secondary user responds to or ignores or terminates an incoming call. SUR call report 370 can include various information such as the identification of the caller, incoming call number, time of incoming call, length of call, a recorded message of the conversation between the caller and the secondary user or a recorded message of a response left on an answering system of the electronic device. SUR call report 370 can also include an indication of the specific response provided by the second user to each received call.

System memory 120 further includes answering system module 380, a numerical tracker of number of secondary user answered calls 390, number of secondary user declined calls 391, threshold number of secondary user answered calls 392, threshold number of secondary user declined calls 394, and threshold number of secondary user unanswered calls 396. Answering system module 380 enables the playing of a greeting and the recording of a message from a caller when an incoming call has been declined to be answered or has not been answered after a period of time or number of rings. Answering system module 380 can also transcribe a recorded message into text that can be viewed on display 130. Number of secondary user answered calls 390 is the number of incoming calls that a secondary user has answered or responded to. Number of secondary user declined calls 391 is the number of incoming calls that a secondary user has manually declined (by selecting the decline option) to answer. Threshold number of secondary user answered calls 392 is a maximum number of calls that a secondary user can respond to before electronic device 100 disables a call response function on the electronic device for the secondary user. Threshold number of secondary user declined calls 394 is a maximum number of calls that a secondary user can decline before electronic device 100 disables a call response function on the electronic device for the secondary user. Threshold number of secondary user unanswered calls 396 is a maximum number of calls that a secondary user does not answer or declines before electronic device 100 disables a call response function on the electronic device for the secondary user. It is appreciated that, in some embodiments, an early termination of a call ring cycle can be considered an active response to a call, as the calling party is aware that the receiving party has rejected the call. In one embodiment, threshold number of secondary user answered calls 392, threshold number of secondary user declined calls 394, and threshold number of secondary user unanswered calls 396 can be selected by the primary user. In another embodiment, threshold number of secondary user answered calls 392, threshold number of secondary user declined calls 394, and threshold number of secondary user unanswered calls 396 can be based on the age of the secondary user. The primary user can input an age of a secondary user and electronic device 100 can select the specific threshold numbers based on the secondary user age and use the threshold numbers in making decisions about operation in the second operating mode as per the age of the secondary user.

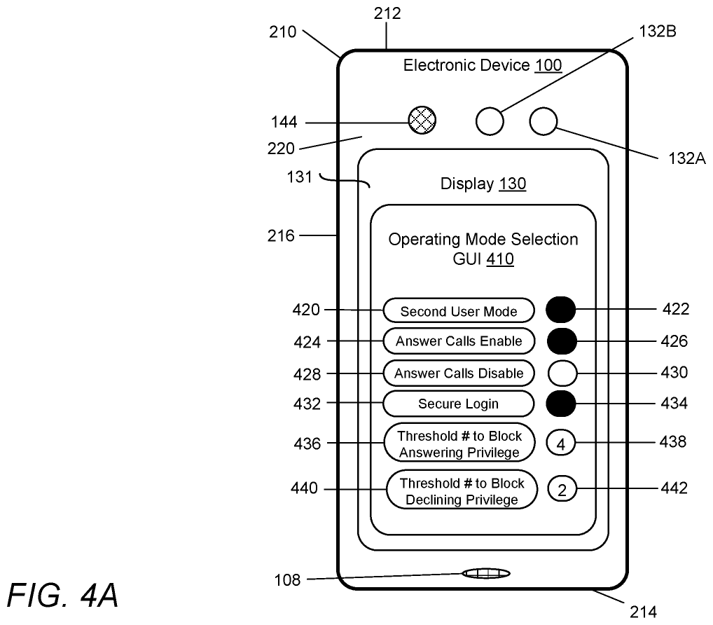

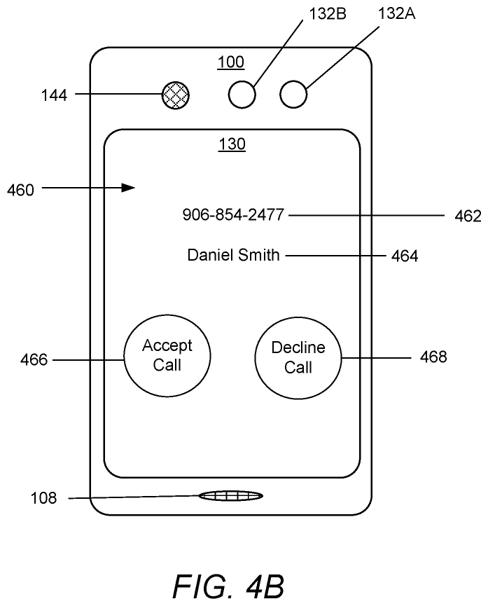

With reference to FIG. 4A, electronic device 100 is shown with an example graphical user interface (GUI) 410 presented on display 130. GUI 410 allows a primary user of electronic device 100 to set-up and select various options for the operation of electronic device 100 in the second operating mode 334. GUI 410 includes second operating mode selection option 420, answer calls enable selection option 424, disable calls selection option 428, secure login option 432, threshold number of calls option 436 to block answering privileges, and threshold number of calls option 440 to block declining privileges. Second operating mode selection option 420. when selected, enables operation of electronic device 100 in a mode for use by a secondary user. with specific device features, restrictions, etc., enabled or disabled for the secondary user. Option on/off indication 422 is filled in or checked when the second operating mode selection option 420 is selected. Answer calls enable selection option 424, when selected, enables operation of electronic device 100 in allow response mode 336A that permits a secondary user of electronic device 100 to respond to an incoming call. Option on/off indication 426 is filled in or checked when the answer calls enable selection option 424 is selected. Disable calls selection option 428, when selected, enables prevent response mode 336B that prevents a secondary user of electronic device 100 from responding to an incoming call. When the option is not selected, the on/off indication circle 430 is not filled in. Secure login option 432, when selected, enables the validation/authentication of the primary user to electronic device 100 before SUR call report 370 can be viewed. Option on/off indication circle 434 is filled in a solid color when secure login option 432 is selected. Threshold number of calls to block answering privilege option 436 sets the value of threshold number of secondary user answered calls 392 before the device blocks the notification of other incoming calls while the device is in the secondary operating mode. The selected threshold number of secondary user answered calls 392 is shown in selection block 438. Threshold number of calls to block declining privilege option 440 sets the value of threshold number of secondary user declined calls 391 before the device blocks the notification of other incoming calls while the device is in the secondary operating mode. The selected threshold number of secondary user declined calls 391 is shown in selection block 442.

FIG. 4B illustrates an example graphical user interface (GUI) 460 presented on display 130 of electronic device 100 during the presentation/notification of an incoming call. GUI 460 includes caller number 462, caller identifier 464, accept call icon 466 and decline call icon 468. A user can select accept call icon 466, via touch screen interface 131, to answer the incoming call or select decline call icon 468 to decline to answer the incoming call. The user can also simply ignore the call, which eventually terminates the ring cycle. When electronic device 100 detects an incoming call, electronic device 100 can further generate an audio ring tone via speaker 144 and cause the electronic device to vibrate via vibration device 146 in order to alert a user to the incoming call. In an embodiment, the selection of decline call icon 468 can trigger the end of the ring tone and vibration. In one or more additional embodiments, a specific movement of the electronic device (e.g., shaking the device or turning the device over on to its face) can turn off the volume of the ring tone, which can also be recorded within the SUR call report as a response by the user. In one embodiment, the selection of decline call icon 468 can further trigger answering system module 380 to answer the incoming call.

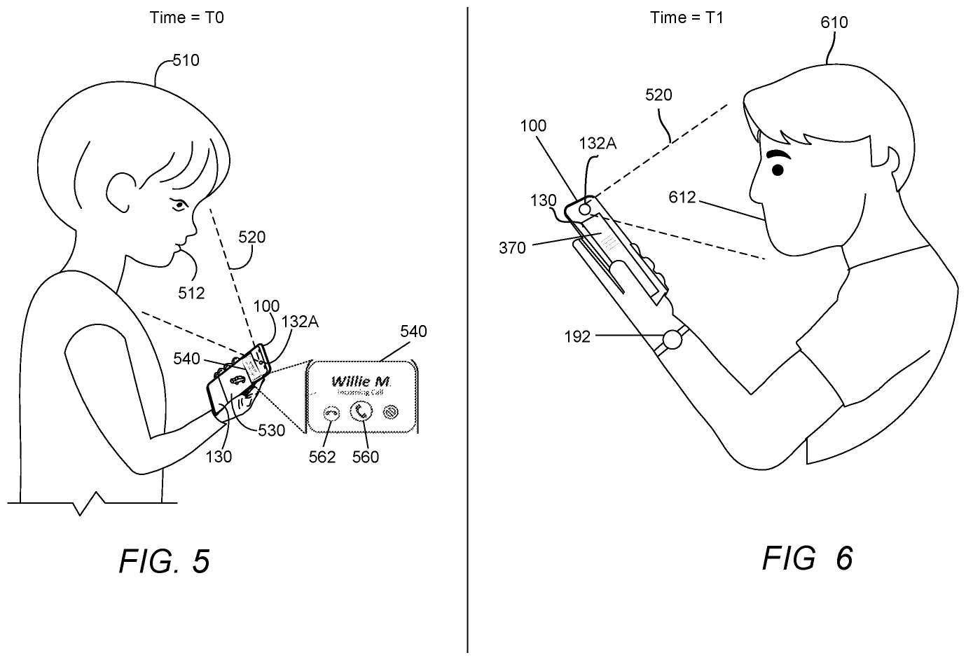

FIG. 5 illustrates an example of a secondary user 510 viewing and/or interacting with content presented on display 130 at/on front surface 220 of electronic device 100, where the display is not currently visible to and/or is not being viewed by the primary user. In one embodiment, the secondary user can be a child, and has a face 512 that is visible to front camera 132A. Secondary user 510 is in a field of view 520 of front camera 132A during an incoming call at an initial time T0. In the example embodiment of FIG. 5, electronic device 100 is operating in the second operating mode 334. The secondary user 510 is interfacing with the electronic device, such as by playing a game application 530, and is looking at or viewing display 130 when a call notification 540 of the incoming call is received and surfaced on the display. Call notification 540 includes the name of the incoming caller, accept call icon 560, and decline call icon 562. The secondary user can select accept call icon 560, via touch screen interface 131, to answer the incoming call or select decline call icon 562 to decline to answer the incoming call.

In one or more embodiments, electronic device 100 can identify the current user of electronic device 100 based on biometric data. Electronic device 100 can trigger a sensor (i.e., image capture device 132A) to capture first image 352 within field of view 520 and authenticate that the image does not correspond to the reference image 362 of the primary user of electronic device 100 and/or identify that electronic device 100 is being operated by secondary user 510. Alternatively, electronic device 100 can trigger another sensor (i.e., microphone 108 or fingerprint sensor 147) to transmit biometric data (e.g., first audio data 354 or first fingerprint data 356) and authenticate that the biometric data does not correspond to reference biometric data (e.g., reference audio data 364 or reference fingerprint data 366) of the primary user of electronic device 100 and/or identify that electronic device 100 is being operated by secondary user 510.

According to one aspect of the disclosure, electronic device 100 can detect activation of second operating mode 334 from a primary operating mode 332. The primary operating mode 332 is associated with the electronic device being operated by a primary user of the electronic device and the second operating mode 334 is associated with electronic device 100 being operated by a secondary user 510 of the electronic device. Electronic device 100 can identify that electronic device 100 is currently being used by the secondary user 510 based on biometric data 350, as previously described, or based on user input credentials, in alternate embodiments. In response to detecting a first incoming call, while the electronic device 100 is in the second operating mode 334, electronic device 100 determines whether the second operating mode 334 includes the activation of allow response sub-mode 336A that enables the secondary user 510 to respond to the first incoming call. In response to the secondary user 510 being able to respond to the first incoming call, electronic device 100 surfaces the call notification 540 with selectable response options 560 and 562 and detects whether the first incoming call is responded to by the secondary user 510. In one or more embodiments, the secondary user 510 responds to the first incoming call by the selection of accept call icon 560. In response to detecting that the first incoming call was responded to by the secondary user 510, electronic device 100 records the response during the first incoming call to SUR call report 370. In one or more alternate embodiments, electronic device 100 also records unanswered calls and declined calls (i.e., early-termination of a call notification) within SUR call report 370.

Referring to FIG. 6, primary user 610 is shown viewing front surface 220 and display 130 of electronic device 100 at a later time T1, after primary user 610 has retrieved his/her electronic device from the secondary user 510. Primary user 610 has a face 612 that is in a field of view 520 of front camera 132A. From this position, primary user 610 can look at or view display 130. Electronic device 100 can identify the current user of electronic device 100 based on biometric data. For example, electronic device 100 can trigger a sensor (i.e., image capture device 132A) to capture first image 352 within field of view 520 and authenticate that the image includes a face that corresponds to the reference image 362 of the primary user of electronic device 100. When the reference image 362 matches the captured first image 352 (or vice versa), processor 102 can identify that electronic device 100 is being operated by primary user 610, or that primary user 610 is in a line of sight of display 130, or that primary user 610 is within an audible range of an incoming call ring signal generated by the speaker 144. Alternatively, electronic device 100 can trigger another sensor (i.e., microphone 108 or fingerprint sensor 147) to transmit biometric data (e.g., first audio data 354 from captured speech or first fingerprint data 356) and authenticate that the biometric data corresponds to reference biometric data (e.g., reference audio/speech data 364 or reference fingerprint data 366) of the primary user of electronic device 100. Similarly, processor 102 can identify that electronic device 100 is being operated by primary user 610, or that primary user 610 is in a line of sight of display 130, or that primary user 610 is within an audible range of an incoming call ring signal generated by the speaker 144.

In FIG. 6, primary user 610 is shown wearing a second electronic device 192, such as a smart watch. Second electronic device 192 can wirelessly communicate with electronic device 100 via short range communication device 164. Electronic device 100 can determine if primary user 610 is within an audible range of an incoming call ring signal generated by the audio output device 144 based on the second electronic device 192 being within the communication range of short range communication device 164.

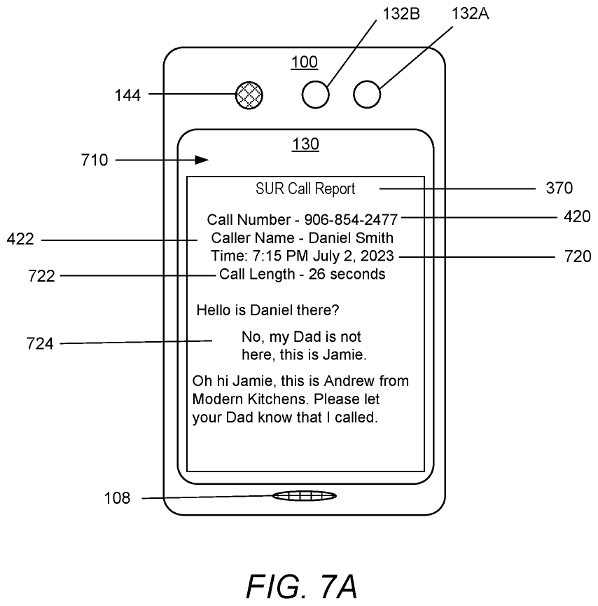

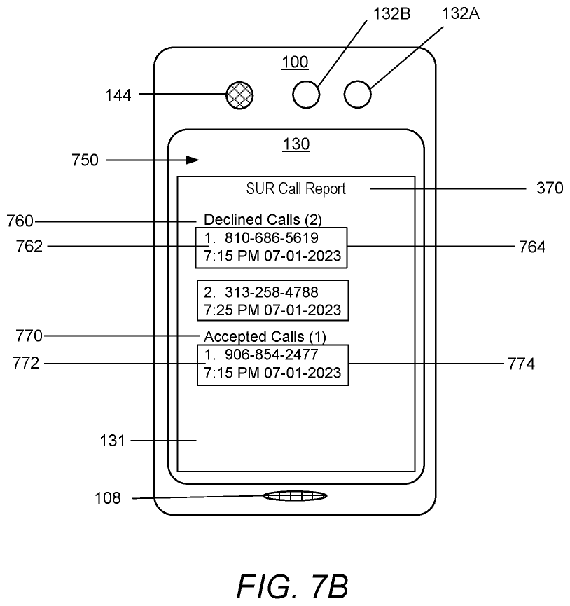

According to another aspect of the disclosure, electronic device 100 can detect that the primary user 610 is subsequently monitoring the electronic device 100 based on matching biometric data 350, as previously described. In response to detecting monitoring/viewing by the primary user 610 of the display of the electronic device 100, electronic device 100 autonomously presents the SUR call report 370 (see FIG. 7A) on display 130 with call response details. Electronic device 100 can further detect that the primary user 610 is monitoring the electronic device 100 based on a handover of electronic device 100 to the primary user or identifying/determining that the primary user 610 is looking towards and can view incoming call notification(s) or notification of a SUR report on display 130, or detecting a transition of electronic device 100 to the primary operating mode 332 by entry of the primary user login/authentication credentials.

FIG. 7A illustrates an example graphical user interface (GUI) 710 with an example SUR report 370 presented on display 130 of electronic device 100 after the processor detects that primary user 610 is monitoring electronic device 100, subsequent to the generation of the SUR report. SUR call report 370 contains call response details, which includes the recorded response to an answered call between the secondary user 510 and the caller who placed the incoming call. SUR call report 370 comprises caller number 462, caller identifier 464, time of call 720, length of call 722, and message 724. In one embodiment, electronic device 100 can transcribe a recorded conversation into message 724. In another embodiment, SUR call report 370 and/or the recording of message 724 can be presented in an audio format via speaker 144.

FIG. 7B illustrates another example GUI 750 with another example SUR report 370 presented on display 130 of electronic device 100 after the processor detects that primary user 610 is monitoring electronic device 100, subsequent to the generation of the SUR report. SUR call report 370 contains call response details to multiple incoming calls including two declined calls 760 that the secondary user has declined and one answered call 770 that the secondary user has answered. Declined calls 760 includes a call log 762 with caller number, time and date details. Declined calls selection block 764 presents declined calls 760. The selection of declined calls selection block 764 by the primary user triggers the presentation of another GUI with additional call details such as the number of rings before the call was declined. Answered calls 770 includes a call log 772 with caller number, time and date details. Answered calls selection block 774 includes answered calls 770. The selection of answered calls selection icon 774 by the primary user triggers the presentation of GUI 710 as previously described in FIG. 7A.

According to one aspect of the disclosure, electronic device 100 can determine if the first image 352 includes the primary user 610 within field of view 520 and in a line of sight to view the display 130 of the electronic device or within an audible range of an incoming call ring signal generated by the audio output device 144 of the electronic device. In one embodiment, electronic device 100 gradually increases a ringer volume for each ring, while in the second operating mode, in order to attract attention of the primary user 610 to the incoming call.

According to another aspect of the disclosure, electronic device 100 can update the SUR call report 370 with each subsequent call response made by the secondary user 510 during operation in the second operating mode 334. Electronic device 100 identifies when a number of secondary user answered or declined calls recorded within the SUR call report 370 reaches a threshold value of secondary user answered calls 392 or secondary user declined calls 394, or secondary user unanswered calls 396, and electronic device 100 subsequently disables a call response function on the electronic device for the secondary user (e.g., disables allow response sub-mode 336A and enables prevent response sub-mode 336B).

According to an additional aspect of the disclosure, electronic device 100 can prevent the secondary user 510 from responding to the first incoming call once the electronic device is placed in the second operating mode. The second operating mode can, in one additional embodiment, operate as a “do not disturb” mode, where calls are not surfaced as a notification on the display or presented as an audible ring or vibration on electronic device 100. A call log of missed calls is then recorded as the SUR report 370, enabling the primary user to later return the important calls that were received by the electronic device.

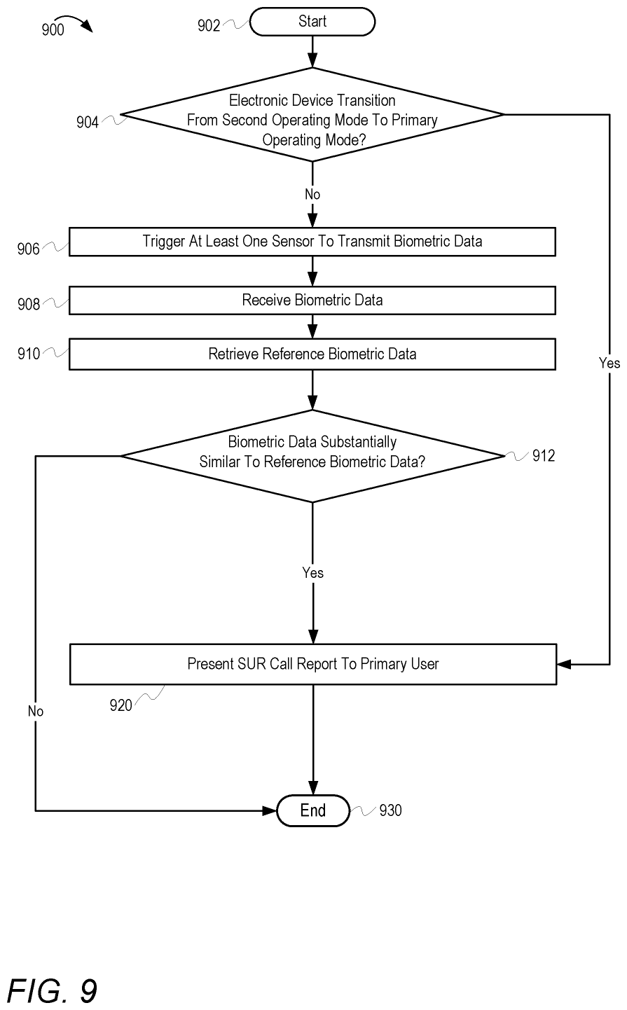

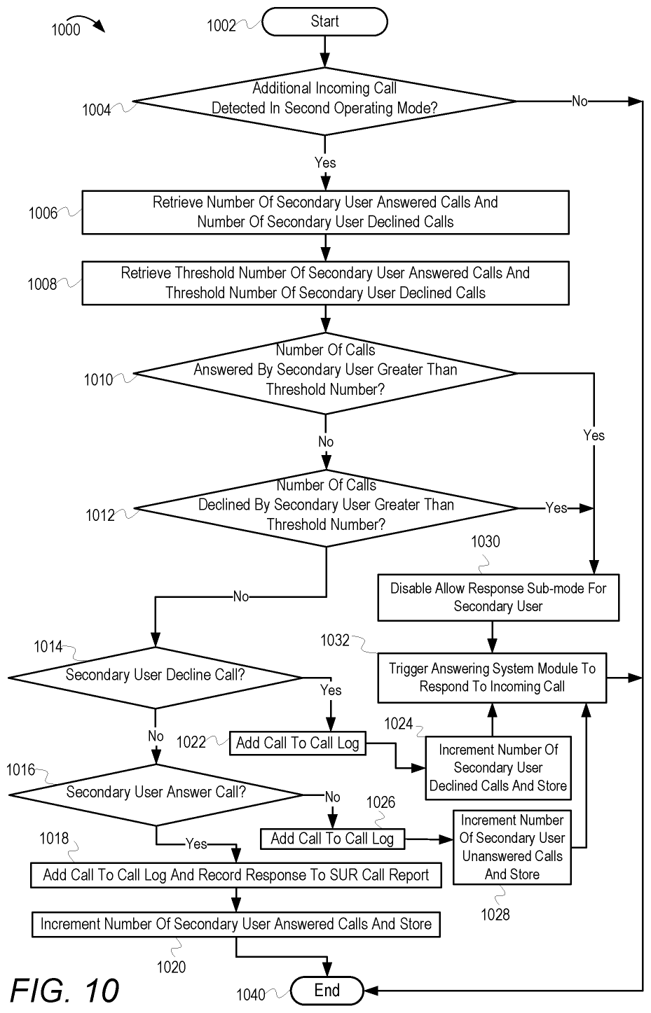

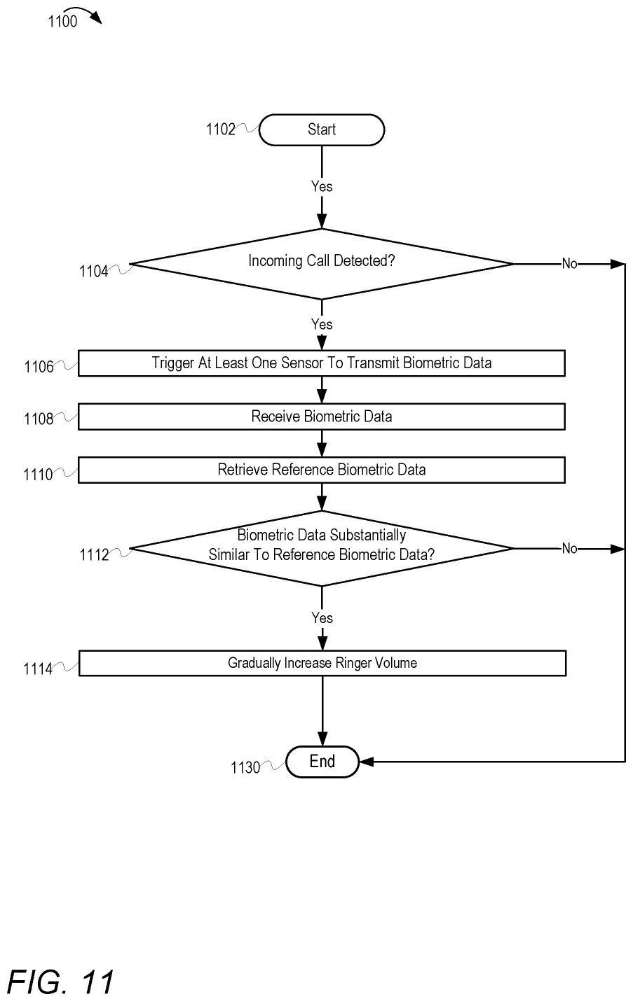

FIG. 8 depicts method 800 by which electronic device 100 manages an incoming call that is responded to by a secondary user. FIG. 9 depicts method 900 by which electronic device 100 determines that the primary user is subsequently monitoring the electronic device and presents a SUR call report. FIG. 10 depicts method 1000 by which electronic device 100 detects that the electronic device is receiving an additional incoming call. FIG. 11 depicts method 1100 by which electronic device 100 increases a ringer volume during an incoming call. The description of methods 800, 900, 1000, and 1100 will be described with reference to the components and examples of FIGS. 1-7B. The operations depicted in FIGS. 8-11 can be performed by electronic device 100 or any suitable electronic device that includes at least one camera and the one or more functional components of electronic device 100 that provide/enable the described features. One or more of the processes of the methods described in FIGS. 8-11 may be performed by processor 102 executing program code associated with CMM 136 and BRM 137.

With specific reference to FIG. 8, method 800 begins at the start block 802. At block 804, processor 102 detects selection of the second operating mode 334 via second user mode option 420 selection by the primary user 610. Processor 102 activates second operating mode 334 and transitions the electronic device to the second operating mode 334 from the primary operating mode 332 (block 806). The primary operating mode is associated with the electronic device being operated by the primary user of the electronic device, and the second operating mode is associated with the electronic device being operated by a secondary user of the electronic device. Processor 102 monitors for and determines if an incoming call has been received (decision block 808). In response to determining that an incoming call has not been received, processor 102 returns to decision block 808 to continue monitoring for and determining if an incoming call has been received.

In response to determining that an incoming call has been received, processor 102 determines if the second operating mode 334 (i.e., the primary user's setting for responding to calls received while the device is in the second operating mode 334), allows the secondary user 510 to respond to the incoming call (decision block 810). For example, the secondary user 510 can respond to the incoming call when allow response sub-mode 336A (FIG. 3) is activated. In response to determining that the second operating mode 334 does not allow the secondary user 510 to respond to the incoming call (i.e., prevent response sub-mode 336B (FIG. 3) is activated), processor 102 adds details of the incoming call to call log 762 of SUR call report 370 (block 820) and triggers answering system module 380 to respond to the incoming call (block 822). Method 800 then ends at end block 830.

In response to determining that the second operating mode 334 allow the secondary user 510 to respond to the incoming call, processor 102 determines if the secondary user has answered or responded to the incoming call (decision block 812). In response to determining that the secondary user has not answered or responded to the incoming call, processor 102 adds details of the incoming call to call log 762 of SUR call report 370 (block 820) and triggers answering system module 380 to respond to the incoming call (block 822). If the call is declined by the secondary user, processor 102 increments the number of secondary user declined calls 391 by one (block 824) and stores the number of secondary user declined calls 391 to system memory 120 (block 826). Method 800 then ends at end block 830.

In response to determining that the secondary user has answered or responded to the incoming call, processor 102 adds details of the incoming call to call log 762 and records the response to SUR call report 370 (block 814). If the call is answered by the secondary user, processor 102 increments the number of secondary user answered calls 390 by one (block 816) and stores the number of secondary user answered calls 390 to system memory 120 (block 818). Method 800 then terminates at end block 830.

FIG. 9 depicts method 900 by which electronic device 100 determines that primary user 610 is subsequently monitoring the electronic device after the electronic device was operating in the second operating mode 334. With specific reference to FIG. 9, method 900 begins at the start block 902. At block 904, processor 102 determines if electronic device 100 has transitioned from the second operating mode 334 to the primary operating mode 332. In one embodiment, the primary user can change the operating mode 330 from the secondary operating mode 334 to the primary operating mode 332 via the de-selection of second user mode icon 420. In response to determining that electronic device 100 has transitioned from the second operating mode 334 to the primary operating mode 332, processor 102 presents GUI 710 containing SUR call report 370 on display 130 for primary user 610 to view (block 920) Method 900 then ends at end block 930.

In response to determining that electronic device 100 has not transitioned from the second operating mode 334 to the primary operating mode 332, processor 102 triggers at least one sensor (i.e., at least one of microphone 108, cameras 132A-132B, and fingerprint sensor 147) to capture and transmit biometric data 350 (block 906). The biometric data 350 is at least one of first image 352, first audio data 354, and first fingerprint data 354. Processor 102 receives the biometric data 350 from at least one sensor (block 908). Processor 102 retrieves reference biometric data 360 from system memory 120 (block 910). Processor 102 determines if the biometric data 350 is substantially similar to reference biometric data 360 that corresponds to an identity of the primary user 610 of electronic device 100 (decision block 912).

In response to determining that biometric data 350 is not substantially similar to reference biometric data 360, method 800 terminates at end block 930. In response to determining that biometric data 350 is substantially similar to reference biometric data 360, processor 102 presents GUI 710 containing SUR call report 370 on display 130 for primary user 610 to view (block 920) Method 900 then ends at end block 930.

FIG. 10 depicts method 1000 by which electronic device 100 detects that the electronic device is receiving an additional incoming call. Referring to FIG. 10, method 1000 begins at the start block 1002. At block 1004, processor 102 monitors for and determines if an additional incoming call has been received while the device is in the second operating mode 334 and after the initial incoming call of method 800 of FIG. 8. In response to determining that an additional incoming call has not been received, method 1000 ends at end block 1040.

In response to determining that an additional incoming call has been received, processor 102 retrieves the number of secondary user answered calls 390 and the number of secondary user declined calls 391 (block 1006). Processor 102 retrieves threshold number of secondary user answered calls 392 and threshold number of secondary user declined calls 394 (block 1008).

Processor 102 determines if the number of secondary user answered calls 390 is greater than the threshold number of secondary user answered calls 392 (decision block 1010). In response to determining that the number of secondary user answered calls 390 is greater than the threshold number of secondary user answered calls 392. processor 102 disables allow response sub-mode 336A and in doing so activates prevent response sub-mode 336B to prevent the secondary user 510 from responding to (i.e., answering) incoming calls (block 1030). Processor 102 triggers answering system module 380 to respond to the additional incoming call (block 1032). Method 1000 then ends at end block 1040.

In response to determining that the number of secondary user answered calls 390 is not greater than the threshold number of secondary user answered calls 392, processor 102 determines if the number of secondary user declined calls 391 is greater than the threshold number of secondary user declined calls 394 (decision block 1012). In response to determining that the number of secondary user declined calls 391 is greater than the threshold number of secondary user declined calls 394, processor 102 disables allow response sub-mode 336A and in doing so activates prevent response sub-mode 336B to prevent the secondary user 510 from responding to (i.e., declining) incoming calls (block 1030). Processor 102 triggers answering system module 380 to respond to the additional incoming call (block 1032). Method 1000 then ends at end block 1040.

In response to determining that the number of secondary user declined calls 391 is not greater than the threshold number of secondary user declined calls 394, processor 102 determines if the secondary user 510 has declined the call by selection of decline call icon 562 (decision block 1014). In response to determining that the secondary user 510 has declined the call, processor 102 adds the declined call details to call log 762 (block 1022), increments the number of secondary user declined calls 391 by one, and stores the number of secondary user declined calls 391 to system memory 120 (block 1024). Processor 102 triggers answering system module 380 to respond to the additional incoming call (block 1032). Method 1000 terminates at end block 1040.

In response to determining that the secondary user 510 has not declined the additional call, processor 102 determines if the secondary user 510 has answered the additional call by selection of accept call icon 560 (decision block 1016). In response to determining that the secondary user 510 has not answered the additional call by selection of accept call icon 560, processor 102 adds the not answered call details to call log 762 (block 1026), increments the number of secondary user unanswered calls 390 by one, and stores the number of secondary user unanswered calls 390 to system memory 120 (block 1028). Processor 102 triggers answering system module 380 to respond to the additional incoming call (block 1032). Method 1000 then ends at end block 1040.

In response to determining that the secondary user 510 has answered the call by selection of accept call icon 560, processor 102 adds call details of the additional incoming call to call log 762 and records the response to SUR call report 370 (block 1018). If the call is answered by the secondary user, processor 102 increments the number of secondary user answered calls 390 by one and stores the number of secondary user answered calls 390 to system memory 120 (block 1020). Method 1000 then terminates at end block 1040.

FIG. 11 depicts method 1100 by which electronic device 100 increases a ringer volume during an incoming call. Referring to FIG. 11, method 1100 begins at the start block 1102. At decision block 1104, processor 102 monitors for and determines if an incoming call has been received. In response to determining that an incoming call has not been received, method 1100 terminates at end block 1130.

In response to determining that an incoming call has been received, processor 102 triggers at least one sensor (i.e., at least one of microphone 108, cameras 132A-132B, and fingerprint sensor 147) to capture and transmit biometric data 350 (block 1106). Processor 102 receives the biometric data 350 from at least one sensor (block 1108). Processor 102 retrieves reference biometric data 360 from system memory 120 (block 1110). Processor 102 determines if the biometric data 350 is substantially similar to reference biometric data 360 that corresponds to an identity of the primary user 610 of electronic device 100 or that second electronic device 192 (i.e., smart watch) is within a communication range of short-range communication device 164 (decision block 1112). In response to determining that biometric data 350 is substantially similar to reference biometric data 360 (i.e., electronic device 100 is being operated by primary user 610 or primary user is in a line of sight of display 130), or that second electronic device 192 (i.e., smart watch) is within a communication range of short-range communication device 164, processor 102, gradually increases a ringer volume, via audio output device 144, to attract attention of the primary user to the incoming call (block 1114). Method 1100 then ends at end block 1130.

In response to determining that biometric data 350 is not substantially similar to reference biometric data 360 or that second electronic device 192 (i.e., smart watch) is not within a communication range of short-range communication device 164, method 1100 terminates at end block 1130.

In the above-described methods of FIG. 8-11, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a first camera;
a memory having stored thereon a call management module (CMM) for managing incoming calls to the electronic device; and
at least one processor communicatively coupled to the first camera and to the memory, the at least one processor executing program code of the CMM, which enables the electronic device to:
detect activation of the electronic device to a second operating mode from a first operating mode, the first operating mode associated with the electronic device being operated by a primary user of the electronic device and the second operating mode associated with the electronic device being operated by a secondary user of the electronic device;
in response to detecting a first incoming call while the electronic device is in the second operating mode:
determine whether the second operating mode enables the secondary user to respond to the first incoming call; and
in response to the secondary user being able to respond to the first incoming call:
detect whether the first incoming call is responded to by the secondary user; and
in response to detecting that the first incoming call was responded to by the secondary user: record a response during the first incoming call to a secondary user responded (SUR) call report; and autonomously present the secondary user responded call report with call response details following detection of the primary user subsequently monitoring the electronic device.

2. The electronic device of claim 1, wherein to detect whether the first incoming call is responded to by the secondary user, the at least one processor:
receives first biometric data from at least one sensor of the electronic device; and
determines whether the first biometric data is substantially similar to reference biometric data that corresponds to an identity of the primary user of the electronic device.

3. The electronic device of claim 1, further comprising:
a display communicatively coupled to the at least one processor;
an audio output device communicatively coupled to the at least one processor; and
wherein, the at least one processor:
captures a first image using the first camera;
determines if the first image includes the primary user within a field of view and in a line of sight to view the display of the electronic device or within an audible range of an incoming call ring signal generated by the audio output device of the electronic device; and
gradually increases a ringer volume to attract attention of the primary user to the incoming call.

4. The electronic device of claim 1, wherein the at least one processor:
prevents the secondary user from responding to the first incoming call.

5. The electronic device of claim 4, wherein the at least one processor:
updates the SUR call report with each subsequent call response made by the secondary user during operation in the second operating mode;
identifies when a number of secondary user answered calls recorded within the SUR call report reaches a threshold value of secondary user answered calls; and
disables a call response function on the electronic device for the secondary user.

6. The electronic device of claim 1, wherein to detect the primary user subsequently monitoring the electronic device, the at least one processor detects at least one of:
a handover of the electronic device to the primary user;
an image of the primary user looking towards a display of the electronic device; and
a transition of the electronic device to the first operating mode.

7. The electronic device of claim 1, wherein the second operating mode is a child safe mode that restricts access to a first set of content that can be accessed by the electronic device in the first operating mode.

8. A method comprising:
detecting, via at least one processor, activation of an electronic device to a second operating mode from a first operating mode, the first operating mode associated with the electronic device being operated by a primary user of the electronic device and the second operating mode associated with the electronic device being operated by a secondary user of the electronic device;
in response to detecting a first incoming call while the electronic device is in the second operating mode:
determining whether the second operating mode enables the secondary user to respond to the first incoming call; and
in response to the secondary user being able to respond to the first incoming call:
detecting whether the first incoming call is responded to by the secondary user; and
in response to detecting that the first incoming call was responded to by the secondary user: recording a response during the first incoming call to a secondary user responded (SUR) call report; and autonomously presenting the secondary user responded call report with call response details following detection of the primary user subsequently monitoring the electronic device.

9. The method of claim 8, wherein to detect whether the first incoming call is responded to by the secondary user, the method further comprises:
receiving first biometric data from at least one sensor of the electronic device; and
determining whether the first biometric data is substantially similar to reference biometric data that corresponds to an identity of the primary user of the electronic device.

10. The method of claim 8, further comprising:
capturing a first image using a first camera;
determining if the first image includes the primary user within a field of view and in a line of sight to view a display of the electronic device or within an audible range of an incoming call ring signal generated by an audio output device of the electronic device; and
gradually increasing a ringer volume to attract attention of the primary user to the incoming call.

11. The method of claim 8, further comprising:
preventing the secondary user from responding to the first incoming call.

12. The method of claim 11, further comprising:
updating the SUR call report with each subsequent call response made by the secondary user during operation in the second operating mode;
identifying when a number of secondary user answered calls recorded within the SUR call report reaches a threshold value of secondary user answered calls; and
disabling a call response function on the electronic device for the secondary user.

13. The method of claim 8, wherein to detect the primary user subsequently monitoring the electronic device, the method further comprises detecting at least one of:
a handover of the electronic device to the primary user;
an image of the primary user looking towards a display of the electronic device; and
a transition of the electronic device to the first operating mode.

14. The method of claim 8, wherein the second operating mode is a child safe mode that restricts access to a first set of content that can be accessed by the electronic device in the first operating mode.

15. A computer program product comprising:
a computer readable storage device having stored thereon program code which, when executed by at least one processor of an electronic device having at first camera and a memory, enables the electronic device to complete the functionality of:
detecting activation of the electronic device to a second operating mode from a first operating mode, the first operating mode associated with the electronic device being operated by a primary user of the electronic device and the second operating mode associated with the electronic device being operated by a secondary user of the electronic device;
in response to detecting a first incoming call while the electronic device is in the second operating mode:
determining whether the second operating mode enables the secondary user to respond to the first incoming call; and
in response to the secondary user being able to respond to the first incoming call:
detecting whether the first incoming call is responded to by the secondary user; and
in response to detecting that the first incoming call was responded to by the secondary user: recording a response during the first incoming call to a secondary user responded (SUR) call report; and autonomously presenting the secondary user responded call report with call response details following detection of the primary user subsequently monitoring the electronic device.

16. The computer program product of claim 15, wherein to detect whether the first incoming call is responded to by the secondary user, the program code for managing incoming calls comprises program code that further enables the electronic device to complete the functionality of:
receiving first biometric data from at least one sensor of the electronic device; and
determining whether the first biometric data is substantially similar to reference biometric data that corresponds to an identity of the primary user of the electronic device.

17. The computer program product of claim 15, wherein the program code for managing incoming calls comprises program code that further enables the electronic device to complete the functionality of:
capturing a first image using the first camera;
determining if the first image includes the primary user within a field of view and in a line of sight to view a display of the electronic device or within an audible range of an incoming call ring signal generated by an audio output device of the electronic device; and
gradually increasing a ringer volume to attract attention of the primary user to the incoming call.

18. The computer program product of claim 15, wherein the program code for managing incoming calls comprises program code that further enables the electronic device to complete the functionality of:
preventing the secondary user from responding to the first incoming call.

19. The computer program product of claim 18, wherein the program code for managing incoming calls comprises program code that further enables the electronic device to complete the functionality of:
updating the SUR call report with each subsequent call response made by the secondary user during operation in the second operating mode;
identifying when a number of secondary user answered calls recorded within the SUR call report reaches a threshold value of secondary user answered calls; and
disabling a call response function on the electronic device for the secondary user.

20. The computer program product of claim 15, wherein to detect the primary user subsequently monitoring the electronic device, the program code for managing incoming calls comprises program code that further enables the electronic device to complete the functionality of:
detecting at least one of:
a handover of the electronic device to the primary user;
an image of the primary user looking towards a display of the electronic device; and
a transition of the electronic device to the first operating mode.
